(19) United States
(12) Patent Application Publication
(10) Pub. No.: US 2008/0172720 A1
(43) Pub. Date: Jul. 17, 2008

(54) Administering Access Permissions for Computer Resources

(76) Inventors: Patrick S. Botz, Rochester, MN (US); Daniel P. Kolz, Rochester, MN (US); Garry J. Sullivan, Rochester, MN (US)

Correspondence Address: IBM (ROC-BLF), C/O BIGGERS & OHANIAN, LLP, P.O. BOX 1469, AUSTIN, TX, 78767-1469, US

(21) Appl. No.: 11/623,194

(22) Filed: Jan. 15, 2007

(51) Int. Cl. G06F 21/20

(52) U.S. Cl. 726/3

(57) ABSTRACT

Methods, apparatus, and products for administering access permissions for computer resources that include: establishing, for active access permissions for a computer resource for a user, proposed alternative access permissions for the computer resource for the user; receiving, in an access control module of an operating system from the user, a request for access to the resource; determining, by the access control module, whether to grant access to the resource for the request in accordance with the active access permissions for the computer resource for the user; determining, by the access control module, whether access would have been granted for the request in accordance with the proposed alternative access permissions for the resource for the user; and recording, by the access control module, the result of the determination whether access would have been granted.

### BACKGROUND OF THE INVENTION

1. Field of the Invention

The field of the invention is data processing, or, more specifically, methods, apparatus, and products for administering access permissions for computer resources.

2. Description of Related Art

The development of the ENIAC computer system of 1946 is often cited as the beginning of the computer era. Since that time, computer systems have evolved into extremely complicated devices. Today's computers are much more sophisticated than early systems such as the ENIAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

As computer systems have evolved and grown to impact all aspects of society, the need for effective security management for computer resources has also grown. In fact, effective security management is now one of the top priorities for system administrators because implementing more stringent and more appropriate access control policies for today's business computing environments is imperative for improving the overall security of a computing system and the business assets such systems contain. Such continual improvement in access control policies must be pursued because the prevailing assumptions used in today's access control implementations change over time. For example, automatically encrypting and decrypting secured data makes sense in a security management scheme when only a few users from a large group are authorized to access the secured data. Over time, however, everyone in the group may become authorized to access such secured data, and such automatic encryption and decryption may, therefore, lose its utility.

A drawback to updating access control implementations is that such updates are often coupled with a high probability of disruption to the businesses that depend on the computer systems. Such disruptions may equate to hundreds, thousands, or millions of dollars in additional expenses incurred as part of the security management update. Because the probability and costs of business disruption is so high, many businesses often accept the security risks associated with their current access control implementations rather than attempt to improve their access control implementations.

An additional factor that prevents businesses from implementing more appropriate access control policies is the amount of effort required to do so. After years of using a particular computing system, many businesses have thousands or even millions of data files. To implement an improved access control policy, a system administrator must first analyze which users ultimately need access to which data files via which applications or system interfaces. Currently, however, such analysis cannot be accomplished in a business production environment without a significant negative impact to the business. Even if such analysis could be performed with minor impact to a business's production environment, the analysis of which users need access to which data files is manually carried out in current computing environments by the system administrator. The sheer volume of data when analyzed manually creates barriers to implementing improved access controls.

When a business decides to implement improved access controls for their production computing system, a separate system is typically required to recreate the production computing system and to provide testing platform for the new access control implementations. System administrators modify the access control implementation and perform as much testing as possible on the testing platform. When testing the new access control implementations, system administrators aim to run the test platform under normal production system usage patterns. Consequently, when evaluating the results from the testing platform, system administrators have to make assumption regarding their confidence in the similarity between their testing platform and their production environment. Based on the testing result and their confidence assumptions, system administrators may choose to implement various changes in the production computing environment. A drawback to using a separate testing platform for evaluating whether to implement a particular access control policy is the high cost associated with recreating the production computing system and the risk the that two systems will not behave, be configured, or be operated in the same manner.

Because current mechanisms for updating access control policies typically bring a high probability for business disruption, require a significant amount of time, and are exceedingly expensive, businesses often accept the higher security risk associated with inadequate access control policies instead of updating the access permissions for their computer resources. As such, readers will therefore appreciate that room for improvement exists for administering access permissions for computer resources.

### SUMMARY OF THE INVENTION

Methods, apparatus, and products for administering access permissions for computer resources that include: establishing, for active access permissions for a computer resource for a user, proposed alternative access permissions for the computer resource for the user; receiving, in an access control module of an operating system from the user, a request for access to the resource; determining, by the access control module, whether to grant access to the resource for the request in accordance with the active access permissions for the computer resource for the user; determining, by the access control module, whether access would have been granted for the request in accordance with the proposed alternative access permissions for the resource for the user; and recording, by the access control module, the result of the determination whether access would have been granted.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network and block diagram of a system for administering access permissions for computer resources according to embodiments of the present invention.

FIG. 2 sets forth a block diagram of automated computing machinery comprising an exemplary computer useful in administering access permissions for computer resources according to embodiments of the present invention.

FIG. 3 sets forth a diagram illustrating exemplary data structures and relations among data structures that implement an exemplary access control list useful in administering access permissions for computer resources according to various embodiments of the present invention.

FIG. 4 sets forth a flow chart illustrating an exemplary method for administering access permissions for computer resources according to embodiments of the present invention.

FIG. 5 sets forth a flow chart illustrating a further exemplary method for administering access permissions for computer resources according to embodiments of the present invention.

### DETAILED DESCRIPTION OF EXEMPLARY EMBODIMENTS

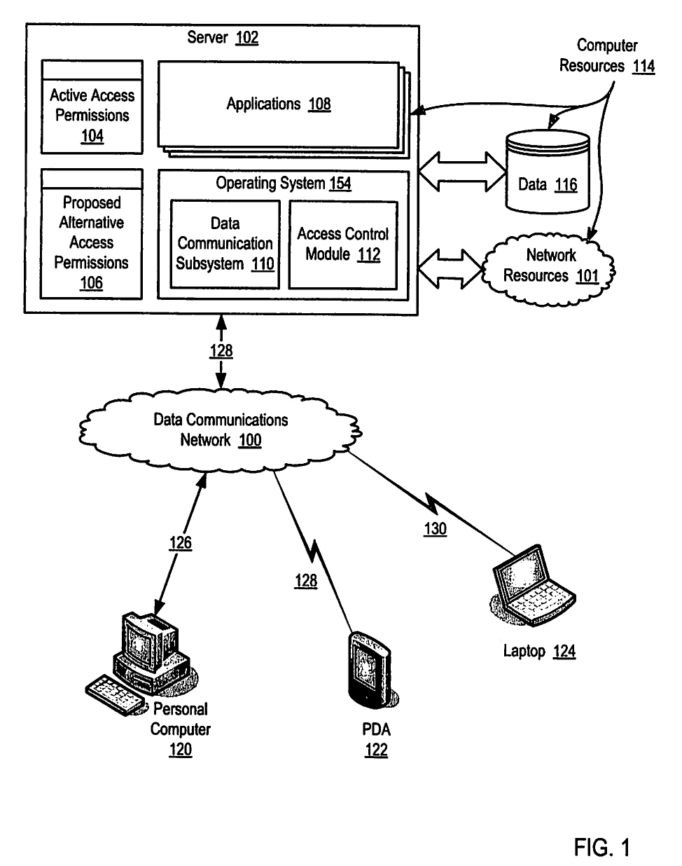

Exemplary methods, apparatus, and products for administering access permissions for computer resources in accordance with the present invention are described with reference to the accompanying drawings, beginning with FIG. 1. FIG. 1 sets forth a network and block diagram of a system for administering access permissions for computer resources according to embodiments of the present invention. The system of FIG. 1 operates for administering access permissions for computer resources in accordance with the present invention as follows: Proposed alternative access permissions (106) for a computer resource (114) for a user are established for active access permissions (104) for the computer resource (114) for the user. An access control module (112) of an operating system (154) receives a request for access to a resource (114) from the user. The access control module (112) determines whether to grant access to the resource (114) in accordance with the active access permissions (104) for the computer resource (114) for the user. The access control module (112) also determines whether access would have been granted for the request in accordance with the proposed alternative access permissions (106) for the resource (114) for the user. The access control module (112) then records the result of the determination whether access would have been granted.

The exemplary system of FIG. 1 includes a server (102). The server (102) is a computer device having installed upon it an operating system (154) that includes an access control module (112). The access control module (112) of FIG. 1 is a software component that restricts the access to the computer resources (114) to authorized users. The term ‘user’ as used in this specification may include a person or a computer process executing on a computer processor. The terms ‘resource’ or ‘computer resource’ mean any information or physical item that is accessible to a user, the access of which is controlled by methods, apparatus, or products according to embodiments of the present invention. The most common kind of resource is a file, but resources may include processes, ports, dynamically-generated query results, the output of Common Gateway Interface (‘CGI’) scripts, dynamic server pages, documents available in several languages, as well as physical objects such as garage doors, briefcases, and so on. Resources often comprise information in a form capable of being identified by a Uniform Resource Identifier (‘URI’) or Uniform Resource Locator (‘URL’). It is useful therefore to consider a resource as similar to a file, but more general in nature. Files as resources include web pages, graphic image files, video clip files, audio clip files, executable applications, and so on. As a practical matter, many resources are either files or dynamic output from server side functionality. Server side functionality may include CGI programs, Java servlets, Active Server Pages, Java Server Pages, and so on. In the example of FIG. 1, the computer resources (114) controlled by the access control module (112) include applications (108) that provide user level data processing, data (116), or access to network resources (101).

The access control module (112) of FIG. 1 includes a set of computer programming instructions for administering access permissions for computer resources according to embodiments of the present invention. The access control module (112) of FIG. 1 operates generally for administering access permissions for computer resources according to embodiments of the present invention by receiving a request for access to a computer resource (114) from a user; determining whether to grant access to the resource for the request in accordance with the active access permissions (104) for the computer resource (114) for the user; determining whether access would have been granted for the request in accordance with the proposed alternative access permissions (106) for the resource (114) for the user; and recording the result of the determination whether access would have been granted.

In the exemplary system of FIG. 1, the server (102) also includes active access permissions (104). Active access permissions (104) is a data structure that specifies the scope of access for a computer resource for a user. The active access permissions (104) are so termed because these access permissions are the actual access permissions used by the access control module (112) to determine whether a user is authorized to access a particular computer resource. The active access permissions (104) may be implemented using an access control list, role-based access controls, context-based access controls, or any other implementation as will occur to those of skill in the art.

An access control list (‘ACL’) is a data structure containing entries that specify individual user or group rights to specific computer resources, such as a program, a input/output port, or a file. These entries are known as access control entries. Each accessible computer resource contains an identifier to an ACL for the resource. The privileges or permissions of a user in an access control entry of the resource's ACL determine the user's specific access rights to the resource, such as whether a user can read from, write to or execute a resource. In some implementations, an access control entry may also specify whether or not a user, or group of users, may alter the ACL of a computer resource.

Role-based access control (‘RBAC’) assigns permissions based on the role of a user, rather than the user itself. In most systems, users are assigned particular roles, and through those role assignments, users acquire the permissions to perform particular system functions. RBAC differs from access control lists used in traditional access control systems in that it assigns permissions to specific computer resources using terms that have meaning within a particular organization, rather than to low-level computer resources such as files, ports, and processes. For example, an access control list may be used to grant or deny write access to a particular system file, but an ACL would not indicate the manner in which the file could be modified. In an RBAC based system, a user may be assigned permissions to create a ‘credit account’ transaction in a financial application or to populate a ‘blood sugar level test’ record in a medical application. The assignment of permissions to perform a particular operation is meaningful in a RBAC because the operations themselves have meaning within the application.

In the example of FIG. 1, the server (102) also includes proposed alternative access permissions (106). Proposed alternative access permissions (106) is a data structure that specifies a proposed alternative scope of access for a computer resource for a user. That is, the proposed alternative access permissions (106) specify access permissions that are not currently used to authorize a user's access to a computer resource, rather such access permissions are proposed as potential access permissions that may be used in the future to authorize a user's access to a computer resource. The proposed alternative access permissions (106) advantageously provide a system administrator with the ability to test new access permissions on the actual system that may eventually implement the proposed alternative access permissions in the future. For example, the active access permissions for a user may allow a user to read, write, and modify a particular data file. Using the proposed alternative access permissions, a system administrator may analyze the effects of more stringent access permissions that allow a user to only read the particular data file. In the exemplary system of FIG. 1, the proposed alternative access permissions (106) are established on the server (102) by a system administrator or by a software component at the direction of a system administrator.

In the exemplary system of FIG. 1, the server (102) connects to data communications network (100) through wireline connection (128). The data communications network (100) provides the infrastructure for connecting together computer devices (102, 120, 122, 124) for data communications using routers, gateways, switching devices, and other network components as will occur to those of skill in the art. The operating system (154) of FIG. 1 includes a data communications subsystem (110) for data communications with other devices (120, 122, 124) connected to network (100) and for data communications with network resources (101). The data communications subsystem (110) may implement such data communications according to the Transmission Control Protocol (‘TCP’), the User Datagram Protocol (‘UDP’), the Internet Protocol (‘IP’), or any other data communication protocol as will occur to those of skill in the art.

In the exemplary system of FIG. 1, various other devices (120, 122, 124) are also connected to the network (100). In the exemplary system of FIG. 1, the personal computer (120) connects to network (100) through wireline connection (126). The personal digital assistant (‘PDA’) (122) connects to network (100) through wireless connection (128). The laptop (124) connects to network (100) through wireless connection (130). In the exemplary system of FIG. 1, a user utilizes each device (120, 122, 124) to request access to one of the computer resources (114).

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example Transmission Control Protocol, Internet Protocol, HyperText Transfer Protocol (‘HTTP’), Wireless Access Protocol (‘WAP’), Handheld Device Transport Protocol (‘HDTP’), and others as will occur to those of skill in the art. Various embodiments of the present invention may be implemented on a variety of hardware platforms in addition to those illustrated in FIG. 1.

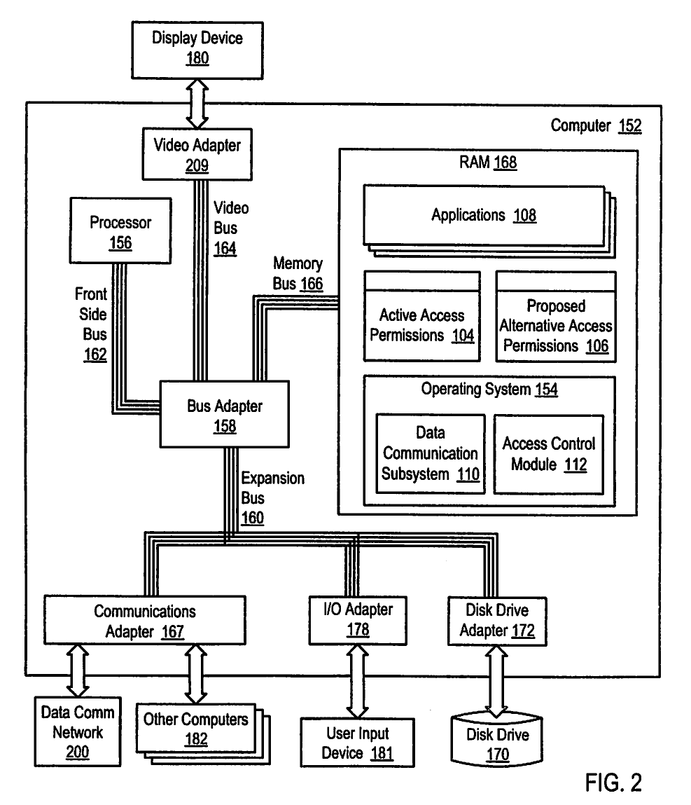

Administering access permissions for computer resources in accordance with the present invention is generally implemented with computers, that is, with automated computing machinery. In the system of FIG. 1, for example, all the nodes, servers, and communications devices are implemented to some extent at least as computers. For further explanation, therefore, FIG. 2 sets forth a block diagram of automated computing machinery comprising an exemplary computer (152) useful in administering access permissions for computer resources according to embodiments of the present invention. The computer (152) of FIG. 2 includes at least one computer processor (156) or ‘CPU’ as well as random access memory (168) (‘RAM’) which is connected through a high speed memory bus (166) and bus adapter (158) to processor (156) and to other components of the computer.

Stored in RAM (168) are applications (108), active access permissions (104), proposed alternative access permissions (106), and operating system (154) that includes access control module (112) and data communications subsystem (110). Each application (108) of FIG. 2 is a set of computer program instructions for user-level data processing. In the example of FIG. 2, active access permissions (104) is a data structure that specifies the scope of access for a computer resource for a user. Proposed alternative access permissions (106) is a data structure that specifies a proposed alternative scope of access for a computer resource for a user. Operating systems useful in computers according to embodiments of the present invention include UNIX™, Linux™, Microsoft XP™, IBM's AIX™, IBM's i5/OS™, and others as will occur to those of skill in the art. The applications (108) and operating system, including the access control module (112) and the data communication subsystem (110), illustrated in FIG. 2 are software components, that is computer program instructions, that operate as described above with reference to FIG. 1. The applications (108), active access permissions (104), proposed alternative access permissions (106), and operating system, including the access control module (112) and the data communication subsystem (110) in the example of FIG. 2 are shown in RAM (168), but many components of such software typically are stored in non-volatile memory also, for example, on a disk drive (170).

The exemplary computer (152) of FIG. 2 includes bus adapter (158), a computer hardware component that contains drive electronics for high speed buses, the front side bus (162), the video bus (164), and the memory bus (166), as well as drive electronics for the slower expansion bus (160). Examples of bus adapters useful in computers useful according to embodiments of the present invention include the Intel Northbridge, the Intel Memory Controller Hub, the Intel Southbridge, and the Intel I/O Controller Hub. Examples of expansion buses useful in computers useful according to embodiments of the present invention may include Peripheral Component Interconnect (‘PCI’) buses and PCI Express (‘PCIe’) buses.

The exemplary computer (152) of FIG. 2 also includes disk drive adapter (172) coupled through expansion bus (160) and bus adapter (158) to processor (156) and other components of the exemplary computer (152). Disk drive adapter (172) connects non-volatile data storage to the exemplary computer (152) in the form of disk drive (170). Disk drive adapters useful in computers include Integrated Drive Electronics (‘IDE’) adapters, Small Computer System Interface (‘SCSI’) adapters, and others as will occur to those of skill in the art. In addition, non-volatile computer memory may be implemented for a computer as an optical disk drive, electrically erasable programmable read-only memory (so-called ‘EEPROM’ or ‘Flash’ memory), RAM drives, and so on, as will occur to those of skill in the art.

The exemplary computer (152) of FIG. 2 includes one or more input/output (‘I/O’) adapters (178). I/O adapters in computers implement user-oriented input/output through, for example, software drivers and computer hardware for controlling output to display devices such as computer display screens, as well as user input from user input devices (181) such as keyboards and mice. The exemplary computer (152) of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 2 includes a communications adapter (167) for data communications with other computers (182) and for data communications with a data communications network (102). Such data communications may be carried out through Ethernet™ connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for administering access permissions for computer resources according to embodiments of the present invention include modems for wired dial-up communications, IEEE 802.3 Ethernet adapters for wired data communications network communications, and IEEE 802.11b adapters for wireless data communications network communications.

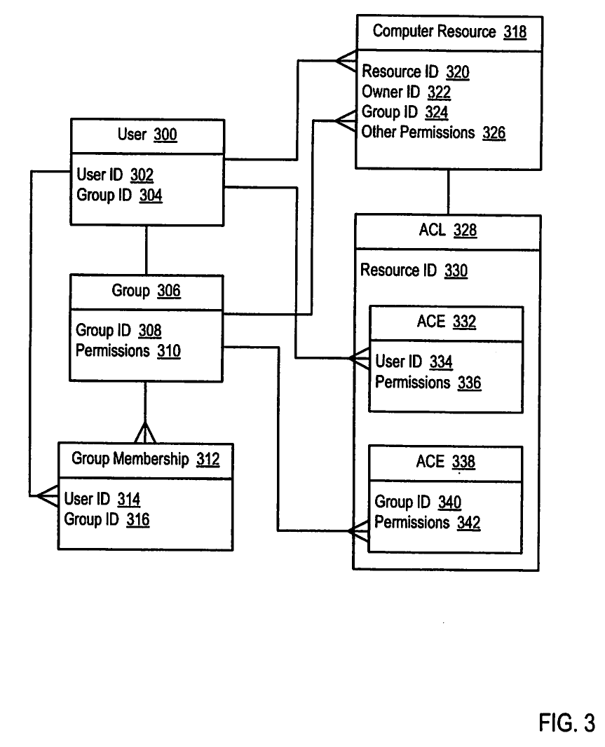

As mentioned above, access permissions may be implemented using access control lists. For further explanation of access control lists and their use in restricting access to computer resources to authorized users, FIG. 3 sets forth a diagram illustrating exemplary data structures and relations among data structures that implement an exemplary access control list useful in administering access permissions for computer resources according to various embodiments of the present invention.

The exemplary data structures of FIG. 3 include a computer resource table (318) for representing computer resources. That is, each record in resource table (318) represents a computer resource. Each resource record includes a resource identification field (320), an owner identification field (322) that functions as a foreign key into user table (300), a group identification field (324) that functions as a foreign key into group table (306), and an other permission field (326) for storing permissions for users who are neither the owner of a resource nor a member of a group with permission to access the resource. Readers will note that the exemplary data structure (318) representing a computer resource is only an example for explanation. The exact structure of a data structure representing a computer resource accessible through a host computer depends on the operating system on the host computer. In Microsoft's MSDOS™, for example, data structures representing computer resources are implemented as entries in a file access table or “FAT.” In many forms of Unix, data structures representing computer resources are implemented as ‘inodes.’ And in Windows NT™, data structures representing computer resources are implemented as records in an array stored in a special file called the Master File Table (‘MFT’).
The exemplary data structures of FIG. 3 also include an access control list (‘ACL’) (328). An ACL is a list of access control entries (‘ACEs’) (332, 338). Each ACE defines a set of permissions for a user (300) or for a group of users (306). The ACL (328), therefore, presides over which users may access a computer resource and what access rights each user may have. Examples of access permissions that may be granted or denied in each ACE include:
permission to change an ACL,
permission to delete a file, directory, or other computer resource,
permission to create a file, directory, or other computer resource,
permission to read a file, directory, or other computer resource,
permission to write to a file, directory, other computer resource, and
permission to search a directory, execute a file, or operate another computer resource.

The exemplary data structures of FIG. 3 include a user table (300). Each record in the user table (300) represents a user, that is a person or computer process, that may be authorized to access computer resources. Each record in the user table (300) includes a user identification field (302) and a group identification field (304) that functions as a foreign key into a group table (306) and identifies a group membership for a user in systems supporting only one group membership per user.

The exemplary data structures of FIG. 3 also include a group table (306). Each record of the group table (306) represents a group of users having the same permissions to access a computer resource. Each group record includes a group identification field (308) and an optional group permissions field (310) measuring the permissions granted for all members of the group to access a computer resource. The group permissions field (310) is optional in the sense that group permissions in systems using ACLs alternatively may be expressed in permissions structures (342) in group ACEs (338).

The exemplary data structures of FIG. 3 include a group membership table (312) that is useful in systems that allow multiple group memberships for each user. Each record of the group membership table (312) represents a user's membership in a group. Each group membership record includes a user identification field (314) that functions as a foreign key to the user records in the user table (300), implementing a one-to-many relationship between the users table (300) and group memberships table (312). Each group membership record includes a group identification field (316) that functions as a foreign key to the group records of the group table (306), implementing a one-to-many relationship between the group table (306) and group memberships (312). The one-to-many relationship between the user table (300) and the group membership table (312) and the one-to-many relationship between the group table (306) and the group membership table (312), taken together, implement a many-to-many relationship between the user table (300) and the group table (306). That is, in such a system, each user may be a member of many groups, and each group may have many member users.

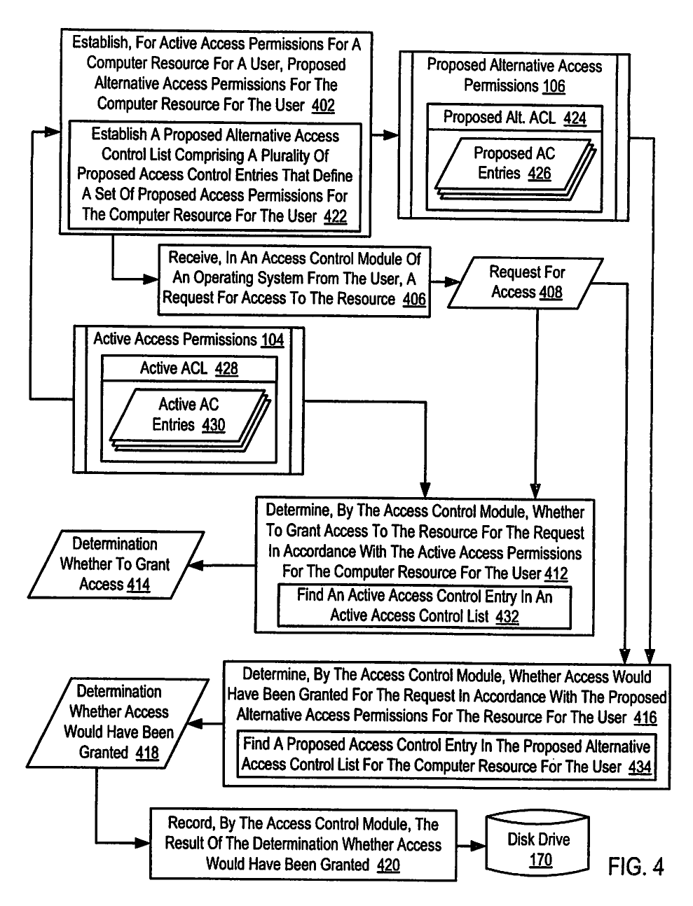

For further explanation, FIG. 4 sets forth a flow chart illustrating an exemplary method for administering access permissions for computer resources according to embodiments of the present invention. The method of FIG. 4 includes establishing (402), for active access permissions (104) for a computer resource for a user, proposed alternative access permissions (106) for the computer resource for the user. As mentioned above, active access permissions (104) of FIG. 4 is a data structure that specifies the scope of access for a computer resource for a user. Active access permissions (104) is so termed because these access permissions are the actual access permissions used by the access control module to determine whether a user is authorized to access a particular computer resource. In the example of FIG. 4, the active access permissions (104) are implemented as an active access control list (428) including a plurality of active access control entries (430) that define a set of active access permissions for the computer resource for the user.

Proposed alternative access permissions (106) of FIG. 4 is a data structure that specifies a proposed alternative scope of access for a computer resource for a user. That is, the proposed alternative access permissions (106) specify access permissions that are not currently used to authorize a user's access to a computer resource, rather such access permissions are proposed as potential access permissions that may be used in the future to authorize a user's access to a computer resource. The proposed alternative access permissions (106) are implemented as a proposed alternative access control list (424) including a plurality of proposed access control entries (426) that define a set of proposed access permissions for the computer resource for the user.

In the method of FIG. 4, establishing (402), for active access permissions (104) for a computer resource for a user, proposed alternative access permissions (106) for the computer resource for the user includes establishing (422) a proposed alternative access control list (424) comprising a plurality of proposed access control entries (426) that define a set of proposed access permissions for the computer resource for the user. The proposed alternative access control list (424) advantageously provides a system administrator with the ability to test new access permissions on the actual computing system that may eventually implement the proposed alternative access permissions in the future. For example, the active access control list for a user may allow a user to read, write, and modify a particular data file. Using the proposed alternative access control list, a system administrator may analyze the effects of more stringent access control policy that allows a user to only read the particular data file. In the exemplary system of FIG. 1, the proposed alternative access control list (424) is established on the computing system by a system administrator or by a software component at the direction of a system administrator.

The method of FIG. 4 also includes receiving (406), in an access control module of an operating system from the user, a request (408) for access to the resource. In the example of FIG. 4, a user may explicitly request access to a particular resource, but as is typically the case, the request for access is usually implied when the user attempts to access the resource directly.

The method of FIG. 4 also includes determining (412), by the access control module, whether to grant access to the resource for the request in accordance with the active access permissions (104) for the computer resource for the user. The access control module determines (412) whether to grant access to the resource for the request in accordance with the active access permissions (104) according to the method of FIG. 4 by finding (432) an active access control entry in the active access control list (428) for the computer resource for the user. If no active access control entry (430) is found in the active access control list (428), the access control module may determine whether to grant access to the resource for the request based on a default value specified in the active access permissions (104). In the example of FIG. 4, the determination (414) whether to grant access represents the result of the access control module's determining whether to grant access to the resource for the request in accordance with the active access permissions (104) for the computer resource for the user. That is, the determination (414) whether to grant access specifies whether a user is authorized to access a resource or not.

The method of FIG. 4 includes determining (416), by the access control module, whether access would have been granted for the request in accordance with the proposed alternative access permissions (106) for the resource for the user. The access control module determines (416) whether access would have been granted for the request in accordance with the proposed alternative access permissions (106) for the resource for the user according to the method of FIG. 4 by finding (434) a proposed access control entry (426) in the proposed alternative access control list (424) for the computer resource for the user. If no proposed access control entry (426) is found in the proposed alternative access control list (424), the access control module may determine whether access would have been granted to the resource for the request based on a default value specified in the proposed alternative access permissions (106). In the example of FIG. 4, the determination (418) whether access would have been granted represents the result of the access control module's determining whether access would have been granted for the request in accordance with the proposed alternative access permissions (106) for the resource for the user. That is, the determination (418) whether access would have been granted specifies whether a user would have been authorized to access a resource or not using the proposed alternative access permissions (106).

In the example of FIG. 4, determining (416), by the access control module, whether access would have been granted for the request in accordance with the proposed alternative access permissions (106) for the resource for the user may be carried out for the request (408) for access at the time when the request (408) is received in the access control module. In such an embodiment, determinations of whether access would have been granted using proposed alternative access permissions are made along with any determinations whether to grant access using active access permissions. In other embodiments, however, the determination of whether access would have been granted may be made based on historical access requests received from the user. The access control module may log access requests as they are received from the user for later analysis using the proposed alternative access permissions.

The method of FIG. 4 also includes recording (420), by the access control module, the result (418) of the determination whether access would have been granted. The access control module may record (420) the result (418) of the determination whether access would have been granted according to the method of FIG. 4 by storing the result (418) of the determination in disk drive (170).

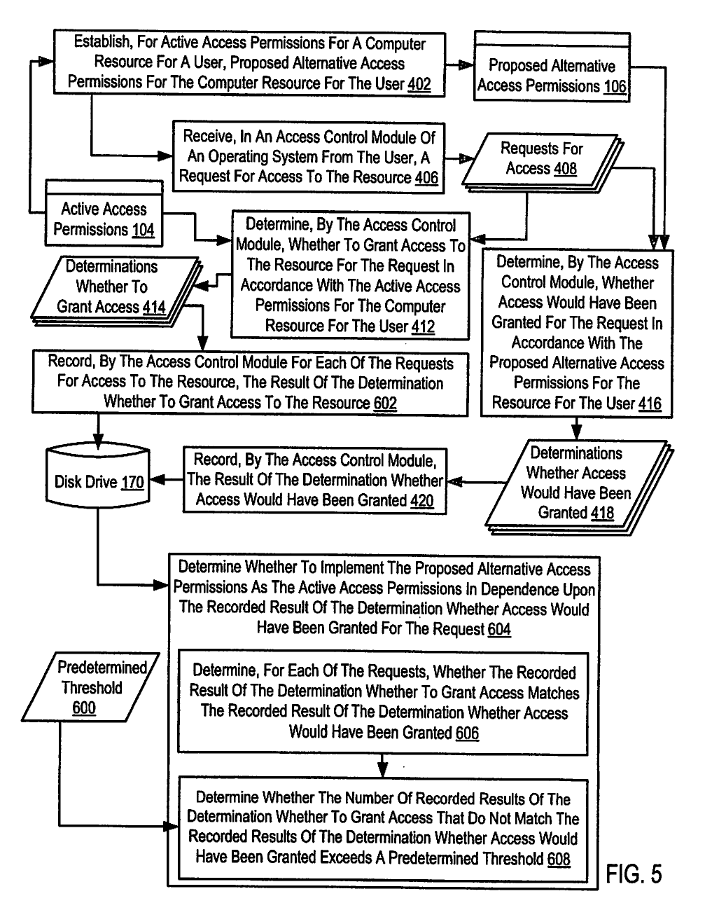

After a period of time of determining whether access would have been granted to a user for a computer resource using proposed alternative access permissions, an access control module or a system administrator may determine whether to implement the proposed alternative access permissions as active access permissions. For further explanation, therefore, FIG. 5 sets forth a flow chart illustrating a further exemplary method for administering access permissions for computer resources according to embodiments of the present invention that includes determining (604) whether to implement proposed alternative access permissions (106) as active access permissions (104).

The method of FIG. 5 is similar to the method of FIG. 4. That is, the method of FIG. 5 includes: establishing (402), for active access permissions (104) for a computer resource for a user, proposed alternative access permissions (106) for the computer resource for the user; receiving (406), in an access control module of an operating system from the user, a request (408) for access to the resource; determining (412), by the access control module, whether to grant access to the resource for the request in accordance with the active access permissions (104) for the computer resource for the user; determining (416), by the access control module, whether access would have been granted for the request in accordance with the proposed alternative access permissions (106) for the resource for the user; and recording (420), by the access control module, the result (418) of the determination whether access would have been granted. In the example of FIG. 5, however, the access control module receives a plurality of requests (408) for access to the resource and records the result (418) of the determination whether access would have been granted for each of the requests (408).

The method of FIG. 5 includes recording (602), by the access control module for each of the requests (408) for access to the resource, the result (414) of the determination whether to grant access to the resource. The access control module may record (602) the result (414) of the determination whether to grant access to the resource according to the method of FIG. 5 by storing the result (414) of the determination in disk drive (170).

The method of FIG. 5 also includes determining (604) whether to implement the proposed alternative access permissions (106) as the active access permissions (104) in dependence upon the recorded result of the determination whether access would have been granted for the request. Determining (604) whether to implement the proposed alternative access permissions (106) as the active access permissions (104) according to the method of FIG. 5 is carried out by determining (606), for each of the requests (408), whether the recorded result (414) of the determination whether to grant access matches the recorded result (418) of the determination whether access would have been granted. Determining (604) whether to implement the proposed alternative access permissions (106) as the active access permissions (104) according to the method of FIG. 5 is further carried out by determining (608) whether the number of recorded results (414) of the determination whether to grant access that do not match the recorded results (418) of the determination whether access would have been granted exceeds a predetermined threshold (600). The predetermined threshold (600) may be implemented as a fixed value such as, for example, one, five, or ten. The predetermined threshold (600) may also be implemented as a calculated value such as, for example, ten percent of the total number of access requests received from a user. Consider, for example, a predetermined threshold having a fixed value of one. In such an example, determining whether to implement proposed alternative access permissions as active access permissions is evaluated by determining whether more than one mismatch occurs between the determination (414) whether to grant access and the determination (418) whether access would have been granted for the same access request.

Exemplary embodiments of the present invention are described largely in the context of a fully functional computer system for administering access permissions for computer resources. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A computer-implemented method of administering access permissions for computer resources, the method comprising:
establishing, for active access permissions for a computer resource for a user, proposed alternative access permissions for the computer resource for the user;
receiving, in an access control module of an operating system from the user, a request for access to the resource;
determining, by the access control module, whether to grant access to the resource for the request in accordance with the active access permissions for the computer resource for the user;
determining, by the access control module, whether access would have been granted for the request in accordance with the proposed alternative access permissions for the resource for the user; and
recording, by the access control module, the result of the determination whether access would have been granted.

2. The method of claim 1 wherein determining, by the access control module, whether access would have been granted for the request in accordance with the proposed alternative access permissions for the resource for the user is carried out for the request for access at the time when the request is received in the access control module.

3. The method of claim 1 further comprising determining whether to implement the proposed alternative access permissions as the active access permissions in dependence upon the recorded result of the determination whether access would have been granted for the request.

4. The method of claim 3 wherein the access control module receives a plurality of requests for access to the resource and records the result of the determination whether access would have been granted for each of the requests, the method further comprising:
recording, by the access control module for each of the requests for access to the resource, the result of the determination whether to grant access to the resource;
wherein determining whether to implement the proposed alternative access permissions as the active access permissions in dependence upon the recorded result of the determination whether access would have been granted for the request further comprises:
determining, for each of the requests, whether the recorded result of the determination whether to grant access matches the recorded result of the determination whether access would have been granted, and
determining whether the number of recorded results of the determination whether to grant access that do not match the recorded results of the determination whether access would have been granted exceeds a predetermined threshold.

5. The method of claim 1 wherein establishing, for active access permissions for a computer resource for a user, proposed alternative access permissions for the computer resource for the user further comprises establishing a proposed alternative access control list comprising a plurality of proposed access control entries that define a set of proposed access permissions for the computer resource for the user.

6. The method of claim 5 wherein determining, by the access control module, whether access would have been granted for the request in accordance with the proposed alternative access permissions for the resource for the user further comprises finding a proposed access control entry in the proposed alternative access control list for the computer resource for the user.

7. The method of claim 1 wherein determining, by the access control module, whether to grant access to the resource for the request in accordance with the active access permissions for the computer resource for the user further comprises finding an active access control entry in an active access control list.

8. Apparatus for administering access permissions for computer resources, the apparatus comprising a computer processor, a computer memory operatively coupled to the computer processor, the computer memory having disposed within it computer program instructions capable of:
establishing, for active access permissions for a computer resource for a user, proposed alternative access permissions for the computer resource for the user;
receiving, in an access control module of an operating system from the user, a request for access to the resource;
determining, by the access control module, whether to grant access to the resource for the request in accordance with the active access permissions for the computer resource for the user;
determining, by the access control module, whether access would have been granted for the request in accordance with the proposed alternative access permissions for the resource for the user; and
recording, by the access control module, the result of the determination whether access would have been granted.

9. The apparatus of claim 8 wherein determining, by the access control module, whether access would have been granted for the request in accordance with the proposed alternative access permissions for the resource for the user is carried out for the request for access at the time when the request is received in the access control module.

10. The apparatus of claim 8 further comprising computer program instructions capable of determining whether to implement the proposed alternative access permissions as the active access permissions in dependence upon the recorded result of the determination whether access would have been granted for the request.

11. The apparatus of claim 10 wherein the access control module receives a plurality of requests for access to the resource and records the result of the determination whether access would have been granted for each of the requests, the apparatus further comprising computer program instructions capable of:
recording, by the access control module for each of the requests for access to the resource, the result of the determination whether to grant access to the resource;
wherein determining whether to implement the proposed alternative access permissions as the active access permissions in dependence upon the recorded result of the determination whether access would have been granted for the request further comprises:
determining, for each of the requests, whether the recorded result of the determination whether to grant access matches the recorded result of the determination whether access would have been granted, and
determining whether the number of recorded results of the determination whether to grant access that do not match the recorded results of the determination whether access would have been granted exceeds a predetermined threshold.

12. A computer program product for administering access permissions for computer resources, the computer program product disposed in a signal bearing medium, the computer program product comprising computer program instructions capable of:
establishing, for active access permissions for a computer resource for a user, proposed alternative access permissions for the computer resource for the user;
receiving, in an access control module of an operating system from the user, a request for access to the resource;
determining, by the access control module, whether to grant access to the resource for the request in accordance with the active access permissions for the computer resource for the user;
determining, by the access control module, whether access would have been granted for the request in accordance with the proposed alternative access permissions for the resource for the user; and
recording, by the access control module, the result of the determination whether access would have been granted.

13. The computer program product of claim 12 wherein the signal bearing medium comprises a recordable medium.

14. The computer program product of claim 12 wherein the signal bearing medium comprises a transmission medium.

15. The computer program product of claim 12 wherein determining, by the access control module, whether access would have been granted for the request in accordance with the proposed alternative access permissions for the resource for the user is carried out for the request for access at the time when the request is received in the access control module.

16. The computer program product of claim 12 further comprising computer program instructions capable of determining whether to implement the proposed alternative access permissions as the active access permissions in dependence upon the recorded result of the determination whether access would have been granted for the request.

17. The computer program product of claim 16 wherein the access control module receives a plurality of requests for access to the resource and records the result of the determination whether access would have been granted for each of the requests, the computer program product further comprising computer program instructions capable of:
recording, by the access control module for each of the requests for access to the resource, the result of the determination whether to grant access to the resource;
wherein determining whether to implement the proposed alternative access permissions as the active access permissions in dependence upon the recorded result of the determination whether access would have been granted for the request further comprises:
determining, for each of the requests, whether the recorded result of the determination whether to grant access matches the recorded result of the determination whether access would have been granted, and
determining whether the number of recorded results of the determination whether to grant access that do not match the recorded results of the determination whether access would have been granted exceeds a predetermined threshold.

18. The computer program product of claim 12 wherein establishing, for active access permissions for a computer resource for a user, proposed alternative access permissions for the computer resource for the user further comprises establishing a proposed alternative access control list comprising a plurality of proposed access control entries that define a set of proposed access permissions for the computer resource for the user.

19. The computer program product of claim 18 wherein determining, by the access control module, whether access would have been granted for the request in accordance with the proposed alternative access permissions for the resource for the user further comprises finding a proposed access control entry in the proposed alternative access control list for the computer resource for the user.

20. The computer program product of claim 12 wherein determining, by the access control module, whether to grant access to the resource for the request in accordance with the active access permissions for the computer resource for the user further comprises finding an active access control entry in an active access control list.
